(19) United States
(12) Patent Application Publication
(10) Pub. No.: US 2025/0320580 A1
(43) Pub. Date: Oct. 16, 2025

(54) RECYCLE STREAM FOR LITHIUM EXTRACTION

(71) Applicant: ExxonMobil Technology and Engineering Company, Spring, TX (US)

(72) Inventor: Sean A. MASON, Houston, TX (US)

(21) Appl. No.: 19/082,670

(22) Filed: Mar. 18, 2025

Related U.S. Application Data
(60) Provisional application No. 63/634,245, filed on Apr. 15, 2024.

(51) Int. Cl. C22B 26/12; C01D 15/08; C22B 3/22; C22B 3/42

(52) U.S. Cl. CPC C22B 26/12; C01D 15/08; C22B 3/22; C22B 3/42

(57) ABSTRACT

A composition, apparatus, and method for enabling improved direct lithium extraction. An exemplary embodiment provides a method of producing a recycle stream. The method includes receiving a nanofilter reject stream and a wash waste water stream from a concentration, refinement, and conversion (CRC) system. The method includes blending the nanofilter reject stream and the wash waste water stream to generate the recycle stream. The recycle stream is to be sent back into the CRC system.

### CROSS-REFERENCE TO RELATED APPLICATION

This application claims priority to and the benefit of U.S. Provisional Application No. 63/634,245, entitled “RECYCLE STREAM FOR LITHIUM EXTRACTION,” having a filing date of Apr. 15, 2024, the disclosure of which is incorporated herein by reference in its entirety.

### FIELD

The present techniques generally relate to extraction of metals from brines. More specifically, the present techniques are directed towards methods and apparatuses for concentration, refinement, and conversion (CRC) of lithium.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 350,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments. An improved process of lithium production is desirable.

### SUMMARY

An exemplary embodiment provides an apparatus for brine filtration. The apparatus includes a recycling unit to receive a nanofilter reject stream and a wash waste water stream from a concentration, refinement, and conversion (CRC) system. The recycling unit is also to blend the nanofilter reject stream and the wash waste water stream to generate a recycle stream. The recycling unit is additionally to send the recycle stream back into the CRC system to extract lithium from the recycle stream.

Another exemplary embodiment provides a method of producing a recycle stream. The method includes receiving a nanofilter reject stream and a wash waste water stream from a concentration, refinement, and conversion (CRC) system. The method also includes blending the nanofilter reject stream and the wash waste water stream to generate the recycle stream. The recycle stream is sent back into the CRC system.

A further exemplary embodiment provides a recycled brine composition. The recycled brine composition includes a blend of output streams from a concentration, refinement, and conversion (CRC) system. The output streams include a nanofilter reject stream and a wash waste water stream. The nanofilter reject stream includes a relatively higher ratio of divalents to lithium than the wash waste water stream. The wash waste water stream includes a relatively higher monovalent to lithium ratio than the nanofilter reject stream. Each of the output streams include lithium.

### BRIEF DESCRIPTION OF THE DRAWINGS

The advantages of the present techniques are better understood by referring to the following detailed description and the attached drawings, in which:

FIG. 1 is an illustration of an apparatus for the extraction of lithium from a lithium-containing brine, according to embodiments herein;

FIG. 2A is an illustration of an apparatus for the removal of ions from a brine stream using a recycle stream, according to an embodiment;

FIG. 2B is an illustration of another apparatus for the removal of ions from a brine stream using a recycle stream, according to an embodiment;

FIGS. 3A and 3B are two parts of an illustration of an apparatus for the removal of ions from a brine stream using a recycle stream, according to another embodiment; and

FIG. 4 is a process flow diagram of a method for recycling reject and waste water streams, according to another embodiment.

### DETAILED DESCRIPTION

As used herein, the following terms shall have the following meanings.

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a direct lithium extraction (DLE) process or concentration, refinement, and conversion (CRC) process.

The term “deep subsurface brine” refers to a saline solution that has circulated through rocks deep in reservoirs such as those found in East Texas, North Dakota, and Arkansas in the United States, and in Alberta, Canada.

The term “divalent” refers to an element having two valence electrons. Example divalents discussed herein include calcium and magnesium.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “filter train” refers to a series or sequence of multiple filtration stages or units arranged in a specific order to remove particulate matter, impurities, or other undesirable substances from a fluid stream. The filter train involves using a step-by-step approach to filtration, with each stage designed to target specific particle sizes or types of contaminants. The goal may be to achieve a high level of filtration efficiency and ensure that a final product meets required quality standards.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, the term “monovalent” refers to an element having one valence electron. Example monovalents discussed herein include sodium, potassium, and lithium.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables from 50% to greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfide (H2S). The present technological innovation generally relates to compositions for preventing sorbent poisoning and pipe corrosion. These techniques generally relates to treated brine compositions with reduced concentrations of H2S that can also be used for recovery of metals, including lithium, manganese, rubidium, cesium, and potassium.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

In various examples, the output of a DLE may be input into a concentration, refinement, and conversion (CRC) unit for conversion into lithium. However, the various components of the CRC process may produce byproduct streams that may include amounts of lithium. Thus, the CRC process may not be completely efficient in converting a lithium brine into a refined lithium product. Moreover, for example, wash water used to wash lithium carbonate crystals washes a lot of sodium along with lithium. Such a waste stream may not be able to be processed using nanofilters because nanofilters separate monovalents from divalents, while sodium and lithium are both monovalents.

Accordingly, embodiments described herein enable improved recovery of lithium and other metals from deep subsurface brines, among other sources of brine. In one embodiment, a CRC process is described with recycled brine stream that increase the percentage of lithium recovered from the brine. An associated recycled brine composition for improved lithium recovery is also described. The use of such a recycled brine composition may enable increased lithium recovery by reducing the amount of lithium wasted in reject and waste streams. In one embodiment, a method for efficient preparation of a recycled brine feed with a balanced mixture of monovalents and divalents is described. The blended composition of such mixture may resemble the brine outlet from the DLE. The techniques described herein thus enable a recycled stream to be fed back into the CRC process and thus additionally processed without special adaptation for each waste or reject stream. In this manner, the techniques enable the reject and waste streams to be further processed using existing systems to extract additional lithium. Thus, the techniques may increase lithium extraction efficiency without significantly increasing overall costs. For example, an 80% additional recovery of lithium present in the recycled stream may increase the overall lithium recovered from the DLE brine by 12%. As a more detailed example, if a nanofilter recovers 90% lithium (with a 10% loss) and the waste wash water recovers 80% lithium (or a 20% loss) then the recycle stream could be used to recover an additional 8% of lithium using the techniques described herein. Furthermore, the techniques may enable less nanofiltration modules to be used to achieve the same lithium extraction levels. For example, a smaller amount of filtration material that allows more lithium to pass through at a higher flux rate may be used and may still result in the same overall amount of lithium to be extracted using the techniques herein. For example, a higher flow rate and thus flux rate may be used to remove more divalent ions, but this may capture lithium less efficiently in a single pass. A system may thus pass more lithium to reject for improved divalent removal, with the knowledge that the increased lithium pass through would have a second pass through the recycling system. In addition, the techniques may also enable wash waste system to operate sub-optimally, removing further amounts of sodium and lithium with the knowledge that the increased lithium would have a second pass through the recycling system. Thus, a strategy of allowing more lithium loss to remove more impurities overall is enabled using the present techniques.

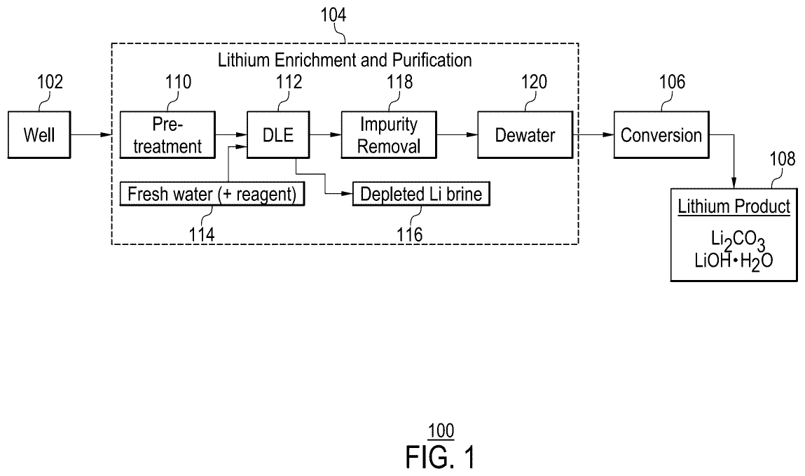

Referring now to FIG. 1, an apparatus 100 for the removal of lithium from a lithium containing brine is provided. A brine containing lithium and other metals is provided via a well 102. The brine received from well 102 may thus be a deep subsurface brine. A lithium enrichment and purification process 104 may then generally purify the brine to produce a purified brine that is sent to a conversion process 106, which converts the brine into a lithium product 108. For example, the lithium product 108 may be lithium carbonate (Li₂CO₃) or lithium hydroxide monohydrate (LiOH H₂O).

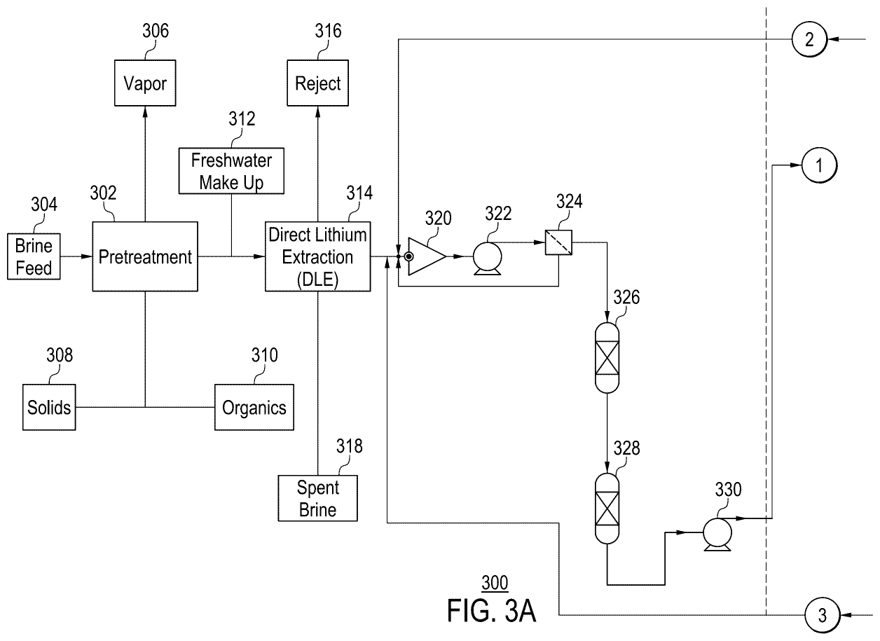

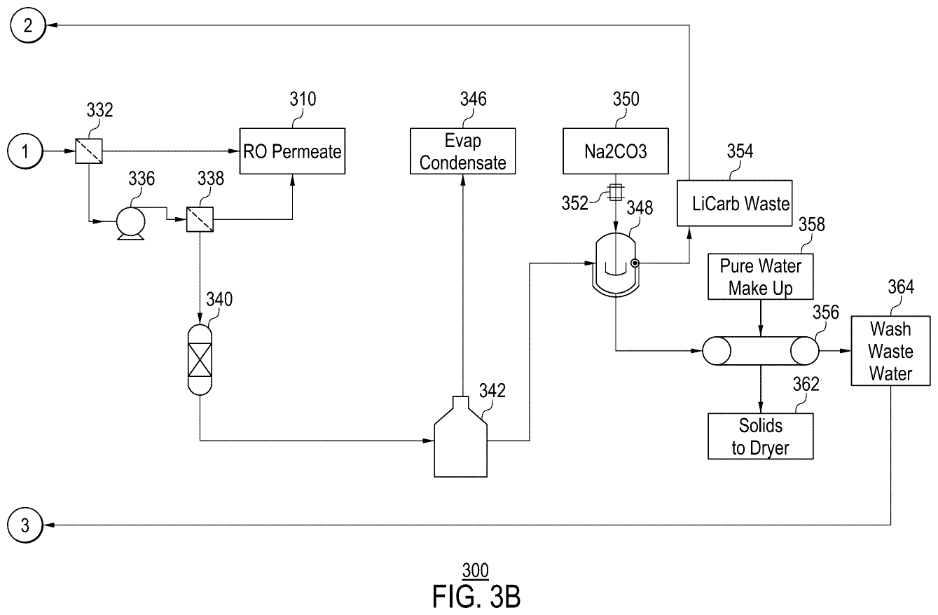

As shown in FIG. 1, the lithium enrichment and purification process 104 includes a pre-treatment process 110. For example, the pre-treatment process 110 may include the use of various technologies, such as those described in greater detail with respect to FIG. 3A below.

Pre-treated brine from the pre-treatment process 110 is then processed via a DLE process 112. The DLE process 112 can increase both the ratio of lithium to impurities and the lithium concentration and, regardless of the technique and materials used, this is accomplished by swapping lithium out of the source brine into a fresh water stream 114. In various examples, depending on the techniques applied, additional reagents may also be added to the fresh water stream 114. For example, such reagents may include sodium sulfate (Na2SO4), sodium hydroxide (NaOH), sodium carbonate (Na2CO3), hydrochloric acid (HCl), or sulfuric acid (H2SO4), among other reagents. Each of the steps before and after DLE process 112 are thus tied to the DLE process 112 and the materials used to promote this swap. If impurities in the water would harm the DLE process 112, then these impurities are first removed and this is done in the pre-treatment process 110.

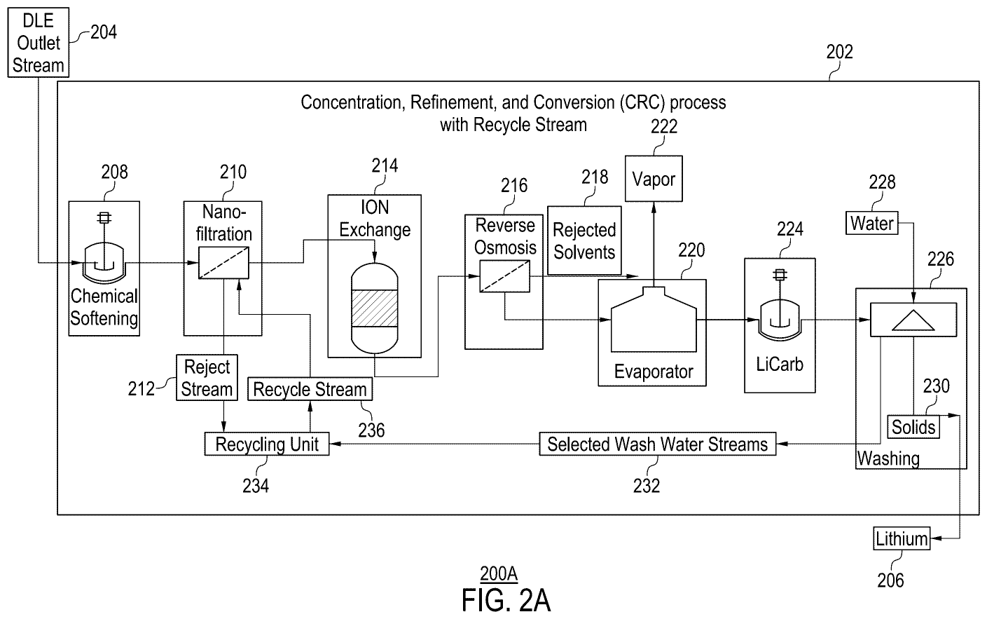

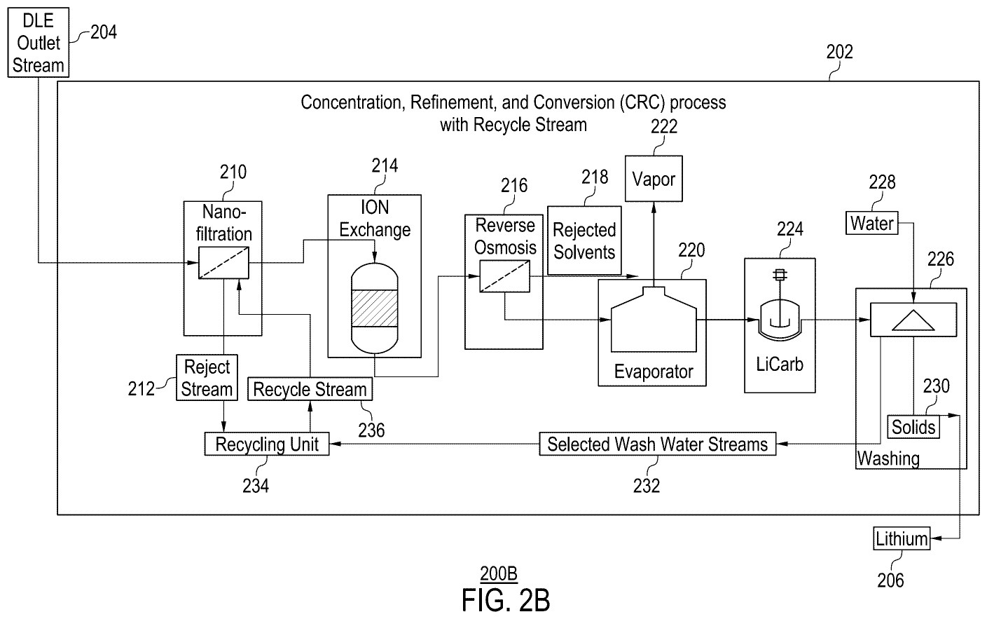

The results of the DLE process 112 is a depleted lithium brine 116 that and a lithium rich water stream that is sent to an impurity removal process 118. For example, the impurity removal process 118 may include the use of various technologies, such as the nanofiltration system 210 among other components of the concentration, refinement, and conversion unit 202 described in FIGS. 2A and 2B below. In various embodiments, the depleted lithium brine 116 may be deposited back into the well 102. In some embodiments, the depleted lithium brine 116 may be additionally treated before being injected into the well 102. In various embodiments, the spent brine is collected from the DLE process 112 and disposed either onto the surface or re-injected into the subsurface reservoir. For surface disposal, regulatory approval may be required, and depending on location, large quantities of impurities may need to be removed. For reinjection, retention of impurities are required to ensure compatibility with the original subsurface brine. In some embodiments, if too many components are depleted from or added to the spent brine relating to the pre-treatment and DLE processing step, then the spent brine may need to be rebalanced to be compatible with the subsurface brine. Otherwise, an incompatible brine may present a risk of excessive scaling and improper pressure maintenance of the reservoir or well 102.

The impurity removal process 118 removes any remaining impurities in the lithium water stream. For example, there may be some amount of impurities that remain with the lithium after the DLE process 112 because no material and technique that can perfectly select for lithium may exist. Therefore, the post-DLE impurity removal process 118 may be used to remove any such remaining impurities. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities.

A dewatering process 120 receives purified lithium solution from the impurity removal process 118. For example, after the DLE process 112, the lithium concentration may still be less than an example target concentration of at least 30,000 ppm, or 150,000 ppm equivalent of lithium carbonate. Therefore, the dewatering process 120 may be applied to remove the water from the purified lithium solution.

In various embodiments, the conversion process 106 then receives purified and concentrated lithium solution from the dewatering process 120 of the lithium enrichment and purification process 104. In some embodiments, once all the above enrichment and purification steps are completed, the lithium enriched brine is fed to the conversion process 106 to produce a saleable battery grade lithium product. For example, the conversion process 106 may include the use of a crystallizer that can generate lithium products such as lithium carbonate, lithium hydroxide monohydrate, lithium sulfate, or lithium phosphate, among other lithium products.

In various embodiments, there thus may be fresh water, chemical, electrical, and sorbent manufacturing requirements to operate a DLE facility using the apparatus 100. In some embodiments, if the apparatus 100 is constructed in a remote location, then delivery of chemicals or sorbents may be unreliable and/or cost of transport of any such chemicals or sorbents may be prohibitive. Therefore, in some embodiments, chemicals and sorbents may also be produced on-site.

FIG. 2A is an illustration of an apparatus 200A for the removal of ions from a brine stream using a recycle stream, according to an embodiment. The apparatus 200A includes a concentration, refinement, and conversion (CRC) unit 202 with recycle stream shown receiving a DLE outlet stream 204 and outputting lithium 206. In some embodiments, the lithium 206 is lithium carbonate. In other embodiments, the lithium 206 is lithium hydroxide. In various embodiments, the CRC unit 202 is fluidically coupled to a DLE unit, from which the DLE outlet stream 204 is received.

The DLE outlet stream 204 may be a stream of brine from a well that has been pretreated via a DLE unit. In some examples, the DLE outlet stream 204 may have been pretreated using any suitable techniques, such as those described in FIG. 1.

The CRC unit 202 includes a chemical softening unit 208. For example, the chemical softening unit 208 may further treat the brine stream 204 by adding one or more salts to the DLE brine stream 204. For example, the salts may include sodium hydroxide (NaOH), sodium sulfate (Na₂SO₄), and sodium carbonate (Na₂CO₃), among other salts. The chemical softening unit 208 may output a stream of softened DLE brine to the nanofiltration system 210.

The CRC unit 202 includes a nanofiltration system 210 that is fluidically coupled to the chemical softening unit 208. In various embodiments, the pretreated stream from the chemical softening unit 208 may be processed through any number of nanofilters to remove any variety of ions. For example, the ions may include calcium, magnesium, or any other ions present in the stream that may need to be removed. On the permeate side of the nanofiltration system 210 that is sent to the ion exchange unit 214, monovalents such as sodium, lithium and potassium are allowed to go through, such that the reject stream 212 is very low in these monovalents and really high in divalents. In various examples, each of the nanofilters may include nano-sized holes through which the brine is passed at a certain flux rate and a certain pH, both of which may depend on the composition of the pretreated brine stream. For example, a stream having high amounts of boron may be processed with a different pH than a stream having low amounts of boron. Similarly, a stream with high amounts of impurities may be processed at a higher flux in order prevent scaling. In various examples, there may be a tradeoff between how much lithium is recovered by the apparatus 200A and how many ions are rejected by the nanofiltration system 210. Therefore, the flux rate may also be kept lower in order to enable more lithium to be efficiently extracted. However, the use of a higher flux rate may be enabled by the use of the recycling that allows additional lithium to be recovered that would have otherwise been wasted. The nanofiltration system 210 is shown receiving softened DLE brine and outputting filtered brine and a reject stream 212. The nanofilter reject stream 212 may have high concentrations of divalents. For example, the output reject stream 212 may include some lithium, along with higher concentrations of divalents such as calcium and magnesium, that may otherwise have been returned to a well, but is instead recycled as described below. For example, the nanofiltering of a DLE brine stream 204 with 600 PPM calcium may result in a reject stream 212 with a concentration of calcium in the range of 4,000 to 8,000 PPM. The nanofiltration system 210 also generates a filtered stream that is sent to the ion exchange unit 214.

The CRC unit 202 also includes an ion exchange unit 214 fluidically coupled to the nanofiltration system 210. The ion exchange unit 214 can interchange of one species of ion present in an insoluble solid with another of like charge present in a solution surrounding the solid. In various embodiments, the insoluble solid is a resin containing a particular ion on its surface. In one embodiment, the resin has sodium (Na+) ions along its surface. In various embodiments, the ions on the resin have higher affinity for divalents, as well as trivalents such as boron. In the example of FIG. 2A, the ion exchange unit 214 is more specifically used to remove divalents and replace them with sodium ions. In one embodiment, the brine flows over the resin and divalents are swapped for sodium ions in the output brine. In various embodiments, the resin-based bed hits saturation and taken offline to regenerate the resin. Thus, in various embodiments, multiple ion exchange beds are used to allow for continuous operations. In some embodiments, the ion exchange beds may include a resin specifically configured for boron and another resin specifically configured for divalents.

The CRC unit 202 also includes a reverse osmosis (RO) unit 216 fluidically coupled to the ion exchange unit 214. The RO unit 216 includes a membrane used to filter solvents 218 from various solutes. RO retains the solute on the pressurized side of the membrane and the purified solvent 218 passes to the other side. In the embodiment of FIG. 2A, the reverse osmosis permeate or purified solvent 218 is purified water. For example, the RO unit 216 can filter lithium solutes as well as other solutes, such as sodium. These solutes are sent in a concentrated stream to the evaporator unit 220. In various embodiments, the purified solvent 218 is used as wash water or DLE brine make up water.

The CRC unit 202 includes an evaporator unit 220 fluidically coupled to the RO unit 216. The evaporator unit 220 is used to evaporate additional solvents such as water from the concentrated stream received from the RO unit 216. In some embodiments, the resulting vapor 222 is released into the environment. In some embodiments, the vapor 222 is cooled and condensed in the evaporator unit 220 and reused as a source of water. In one embodiment, condensed vapor 222 is used as wash water.

The CRC unit 202 further includes a lithium carbonation unit 224 that is fluidically coupled to the evaporator unit 220. The lithium carbonation unit 224 may be used to convert lithium salts such as lithium chloride into lithium carbonate crystals.

The CRC unit 202 further also includes a washing unit 226 fluidically coupled to the lithium carbonation unit 224. In the embodiment of FIG. 2A, the washing unit 226 is shown receiving a stream of lithium carbonate and wash water 228, and outputting produced solids 230 and selected wash water streams 232. In various embodiments, the produced solids 230 are lithium carbonate solids that are output as lithium 206. In some embodiments, the lithium carbonate solids can be processed through a lime addition process to produce lithium hydroxide, which is output as lithium 206. In some embodiments, the wash water 228 is deionized (DI) water. As one example, a stream of wash water 228 may be introduced to generate an output of wash waste water of which a selected subset of wash water streams 232 are recycled. In various embodiments, the washing unit 226 may perform any number of washes on lithium carbonate received from the lithium carbonation unit 224 using the wash water 228. For example, the washing unit 226 may take the form of a horizontal belt filter with a conveyor belt that moves lithium carbonate crystals in a filter through a series of hoses that wash the lithium carbonate with wash water 228. The wash water 228 may extract sodium and lithium chloride that dissolves in the wash water and passes through the filter, leavening purified lithium carbonate crystals behind. In this manner, any number of water washes may be performed in a sequential manner resulting in a number of sequential wash water streams containing less and less sodium, while removing approximately the same amount of lithium chloride in each wash. As one example, a total of five washes may be used, as shown in Table 1 below. In various embodiments, a selected number of the resulting wash water streams 232 may be used for recycling. As one embodiment, a first wash water stream may be discarded and subsequent wash water streams recycled for use as selected wash water streams 232. For example, the first wash water stream may be particularly high in certain extracted salts such as sodium and thus discarded. The compositions of an example set of wash streams with associated reject stream from nanofiltration of an example input brine stream 204 that was processed is shown in Table 1 below:

TABLE 1
Example Reject Stream and Wash Stream Compositions in
Sampled DLE Brine

| Detected | Reject | LiCarb | Wash | Wash | Wash | Wash |
|---|---|---|---|---|---|---|
| Component | Stream | Waste | 1 | 2 | 3 | 4 |
| As (188.98 nm)- | ND | ND | ND | ND | ND | ND |
| Rad | | | | | | |
| B (249.678 nm)- | 136 | 4.6 | 1.7 | 0.82 | 0.50 | 0.38 |
| Rad | | | | | | |
| Ba (455.403 nm)- | 21 | 0.75 | 0.46 | 0.33 | 0.31 | 0.30 |
| Ax | | | | | | |
| Ca (317.933 nm)- | 3380 | 2.8 | 4.1 | 3.9 | 4.0 | 3.8 |
| Ax | | | | | | |
| Fe (259.940 nm)- | 0.13 | 0.07 | 0.08 | 0.09 | 0.05 | 0.08 |
| Ax | | | | | | |
| K (766.491 nm)- | 25 | 41 | 15 | 5.5 | 2.6 | 1.6 |
| Rad | | | | | | |
| Li (670.783 nm)- | 1320 | 1840 | 2020 | 1960 | 1860 | 1850 |
| Rad | | | | | | |
| Mg (285.213 nm)- | 339 | 0.18 | 0.34 | 0.40 | 0.42 | 0.42 |
| Rad | | | | | | |
| Mn (257.610 nm)- | 0.03 | ND | ND | ND | ND | ND |
| Ax | | | | | | |
| Na (589.592 nm)- | 242 | 69400 | 20300 | 7150 | 2380 | 717 |
| Rad | | | | | | |
| Pb (220.35 nm)- | ND | ND | ND | ND | ND | ND |
| Ax | | | | | | |
| Si (288.158 nm)- | 0.14 | 1.2 | 1.5 | 1.7 | 1.5 | 1.5 |
| Rad | | | | | | |
| Sr (407.771 nm)- | 146 | 0.61 | 0.43 | 0.30 | 0.23 | 0.19 |
| Ax | | | | | | |
| Zn (213.857 nm)- | 9.1 | 0.10 | 0.08 | 0.05 | 0.05 | 0.04 |
| Rad | | | | | | |

As seen in Table 1, the reject stream 212 from nanofiltration is relatively high in calcium with a value of 3,380 milligrams per liter (mg/L) or parts per million (ppm) by volume. The reject stream 212 is also high in magnesium with a value of 339 mg/L. By contrast, the reject stream 212 is low in sodium, with a value of 242 mg/L. Such a high ratio of divalents to monovalents may make the reject stream 212 incompatible for recycling in the CRC unit 202 without a significantly more powerful pump to overcome the higher osmotic pressure resulting from the increased concentration of divalents. In comparison, the lithium carbonate waste stream and the wash streams 1-4 are relatively low in calcium and magnesium, with ranges of 2.8-4.0 mg/L and 0.18-0.42 mg/L, respectively. The lithium carbonate waste stream and wash streams 1-4 are also relatively high in sodium when compared with the reject stream, with lithium carbonate waste stream having a very high concentration of 69,400 mg/L and wash stream 4 having a lower concentration of 717 mg/L. Moreover, the lithium carbonate waste stream and wash streams 1-4 may also not generally be easily separately recycled because sodium and lithium are both monovalents and the nanofilters in the nanofiltration system 210 may only be designed to separate monovalents from divalents. Therefore, separating sodium from the lithium in the lithium carbonate waste stream and separate wash streams may be difficult and costly.

The CRC unit 202 thus also includes a recycling unit 234 fluidically coupled to both the nanofiltration system 210 and the washing unit 226. The recycling unit 234 receives the reject stream 212 and the selected wash water streams 232 and blends the two sets of streams together to generate a recycle stream 236 that is output back into the nanofiltration system 210. In various embodiments, the recycling unit 234 blends the reject stream 212 and the selected wash water streams 232 at a predetermined ratio to generate a recycle stream 236 that may have similar composition as the DLE outlet stream 204. An example composition of a nanofiltration (NF) feed and recycled blend feed with a blended volume ratio of 1:2 reject stream to selected wash water with the first wash water stream discarded is shown in the Table 2 below:

TABLE 2
Compared Compositions of Example Nanofiltration
Feed and Recycled Blend Feed

| Detected Component | NF Feed | Blend Feed |
|---|---|---|
| As (188.98 nm)-Rad | ND | ND |
| B (249.678 nm)-Rad | 141 | 68.4 |
| Ba (455.403 nm)-Ax | 4 | 10.8 |
| Ca (317.933 nm)-Ax | 714.53 | 1691.6 |
| Fe (259.940 nm)-Ax | ND | 0.1 |
| K (766.491 nm)-Rad | 19 | 15.1 |
| Li (670.783 nm)-Rad | 1030 | 1429.2 |
| Mg (285.213 nm)-Rad | 66.04 | 169.9 |
| Mn (257.610 nm)-Ax | ND | ND |
| Na (589.592 nm)-Rad | 182.5 | 3175.9 |
| Pb (220.35 nm)-Ax | ND | ND |
| Si (288.158 nm)-Rad | ND | 0.7 |
| Sr (407.771 nm)-Ax | 33.0 | 73.1 |
| Zn (213.857 nm)-Rad | 4.35 | 4.6 |

Components with amounts of less than 0.05 mg/L are indicated as not detected (ND). As seen in Table 2, the values for sodium, calcium, and magnesium are higher than the original NF feed, but the ratio of lithium to impurities (including, for example, Na, Ca, Mg, etc.) is far lower than the reject or wash water stream from Table 1. Example ratios of lithium to divalents and lithium to sodium are shown in Table 3:

TABLE 3
Example Lithium to Impurity Ratios in Feed and
Nanofilter Reject Streams

| Component | | Feed | NF1 | NF2 | NF3 | NF4 | NF5 |
|---|---|---|---|---|---|---|---|
| As (188.98 nm)-Rad | mg/L | ND | ND | ND | ND | ND | ND |
| B (249.678 nm)-Rad | mg/L | 141 | 139 | 142 | 137 | 137 | 137 |
| Ba (455.403 nm)-Ax | mg/L | 4.8 | 5.9 | 9.0 | 26 | 76 | 179 |
| Ca (317.933 nm)-Ax | mg/L | 735 | 914 | 1450 | 4090 | 12330 | 29809 |
| Fe (259.940 nm)-Ax | mg/L | 0.03 | 0.02 | 0.07 | 0.14 | 0.6 | 2.2 |
| K (766.491 nm)-Rad | mg/L | 20 | 22 | 24 | 25 | 21 | 19 |
| Li (670.783 nm)-Rad | mg/L | 1150 | 1180 | 1270 | 1250 | 977 | 803 |
| Mg (285.213 nm)- | mg/L | 72 | 86 | 140 | 415 | 1288 | 3190 |
| Rad | | | | | | | |
| Mn (257.610 nm)- | mg/L | 0.01 | 0.01 | 0.01 | 0.04 | 0.1 | 0.3 |
| Ax | | | | | | | |
| Na (589.592 nm)- | mg/L | 201 | 207 | 228 | 243 | 224 | 210 |
| Rad | | | | | | | |
| Pb (220.35 nm)-Ax | mg/L | ND | ND | ND | ND | ND | ND |
| Si (288.158 nm)- | mg/L | 0.13 | 0.12 | 0.11 | 0.18 | 0.49 | 1.10 |
| Rad | | | | | | | |
| Sr (407.771 nm)-Ax | mg/L | 33 | 40 | 62 | 178 | 540 | 1314 |
| Zn (213.857 nm)- | mg/L | 4.6 | 5.3 | 6.9 | 9.9 | 8.9 | 8.2 |
| Rad | | | | | | | |
| Li:Div | | 1.35 | 1.12 | 0.76 | 0.26 | 0.07 | 0.02 |
| Li:Na | | 5.72 | 5.70 | 5.57 | 5.15 | 4.36 | 3.82 |

In Table 3, testing was performed in a lab to determine nanofilter reject compositions, shown as NF1, NF2, and NF3. In addition, the two feeds, nanofilter reject streams NF4 and NF5 are estimated projections of the harshest potential feeds. At the bottom of the Table 3, the Li:Div ratio is the ppmv ratio of the lithium to divalents, and the Li:Na ratio is the ratio of lithium to sodium. As shown in Table 3, the Li:Div ratio ranges from 1.35 all the way down to 0.26 in the lab samples, and is projected to potentially reach as low as 0.02 in the projections. The ratio of Li:Div decreasing implies that the inverse Div:Li is increasing. As also seen in Table 3, the amount of divalents to lithium in the feed could be as much as 5-20× higher in the nanofilter (NF) reject 3 (NF3) or 4 (NF4) than in the Feed. As also shown in Table 3, the Li:Na ratio goes steadily down from ˜5.7 to as low as 4. Thus, the LiCarb and wash streams can be used to maintain these ratios. Table 4 illustrates how these two streams can be used to change these ratios:

TABLE 4
Example Lithium to Impurity Ratios in Lithium
Carbonate Waste and Wash Waste Steams

| Component | Licarb | Wash 1 | Wash 2 | Wash 3 | Wash 4 |
|---|---|---|---|---|---|
| As (188.98 nm)-Rad | ND | ND | ND | ND | ND |
| B (249.678 nm)-Rad | 5 | 2 | 1 | 1 | 0 |
| Ba (455.403 | 1 | 0 | 0 | 0 | 0 |
| nm)-Ax | | | | | |
| Ca (317.933 | 3 | 4 | 4 | 4 | 4 |
| nm)-Ax | | | | | |
| Fe (259.940 nm)-Ax | 0.1 | 0.1 | 0.1 | 0.1 | 0.1 |
| K (766.491 | 41 | 15 | 6 | 3 | 2 |
| nm)-Rad | | | | | |
| Li (670.783 | 1840 | 2020 | 1960 | 1860 | 1850 |
| nm)-Rad | | | | | |
| Mg (285.213 | 0 | 0 | 0 | 0 | 0 |
| nm)-Rad | | | | | |
| Mn (257.610 | ND | ND | ND | ND | ND |
| nm)-Ax | | | | | |
| Na (589.592 | 69400 | 20300 | 7150 | 2380 | 717 |
| nm)-Rad | | | | | |
| Pb (220.35 nm)-Ax | ND | ND | ND | ND | ND |
| Si (288.158 | 1.20 | 1.50 | 1.70 | 1.50 | 1.50 |
| nm)-Rad | | | | | |
| Sr (407.771 nm)-Ax | 1 | 0 | 0 | 0 | 0 |
| Zn (213.857 | 0.1 | 0.1 | 0.1 | 0.1 | 0.0 |
| nm)-Rad | | | | | |
| Li:Div | 407.98 | 367.94 | 386.59 | 367.59 | 383.02 |
| Li:Na | 0.03 | 0.10 | 0.27 | 0.78 | 2.58 |

In various examples, any combination of the nanofilter reject streams, the wash waste water streams, and the lithium carbonate waste stream can be combined to maximize the Li:Div and Li:Na ratios to generate a stream with the highest lithium to impurities ratios. In some embodiments, one or more of the ratios are decreased to recover more lithium overall. For example, as shown in Table 4, the Li:Div ratio is very high at over 400 mg/L, but the Li:Na ratio is rock bottom at 0.03 up to 2.58 in the Wash 4. Thus, as one embodiment, a blend strategy includes blending all of the streams in Table 4 with the streams in Table 3, preferencing closer to Wash 4 fluid with NF reject, but allowing as much wash 3, 2, 1 and even LiCarb as we could before going too far on the Li:Div ratios or Li:Na ratios. In various embodiments, divalents such as magnesium are in the range from 1-3000 ppmv in the blend feed. In various embodiments, calcium is in the range from 10-16000 ppmv in the blend feed. Thus, the blend feed can be effectively processed via the nanofiltration system 210, the ion exchange unit 214, the reverse osmosis unit 216 and other components of the CRC unit 202 to generate additional lithium 238 from additional produced solids 230. For example, since the concentration of impurities in the recycle stream 236 may be higher than the NF feed, the recycle stream 236 may be input into an advanced stage of the nanofiltration system 210. As one example, the recycle stream 236 may be input into a third stage of the nanofiltration system 210 that is designed to process higher concentrations of impurities. Alternatively, in some embodiments, the recycle stream 236 is instead processed using a dedicated nanofitration train and input into the ion exchange unit 214 of the CRC unit 202. In this manner, the recycle stream 236 can be used to maximize lithium recovery from the brine stream 204. Alternatively, or in addition, the recycle stream 236 is used to enable nanofiltration system 210 to operate sub-optimally and still recover similar amounts of lithium. For example, in one embodiment, the nanofiltration system 210 is configured to pass more lithium in order to reject more divalents, with this additional lost lithium being recovered in a second pass via the recycle stream 236. Similarly, in another embodiment, the recycle stream 236 is alternatively or additionally used to enable the washing unit 226 to operate sub-optimally with respect to lithium extraction. For example, allowing greater amounts of lithium to be removed into the wash streams may also enable larger amounts of sodium to be removed, with the this additional lost lithium again being recovered in the second pass via the recycle stream 236. In some examples, even if 80% of the lithium in the recycle stream is recovered in the second pass, this recovered amount may be up to 12% of the lithium in the original DLE feed that may have otherwise been discarded.

FIG. 2B is an illustration of another apparatus 200B for the removal of ions from a brine stream using a recycle stream, according to an embodiment. The embodiment illustrated in FIG. 2B includes similarly numbered elements present in the apparatus 200A of FIG. 2A. However, FIG. 2B excludes the chemical softening unit 208. Thus, in some embodiments, the DLE output stream 204 is received directly at the nanofiltration unit 210 in FIG. 2B.

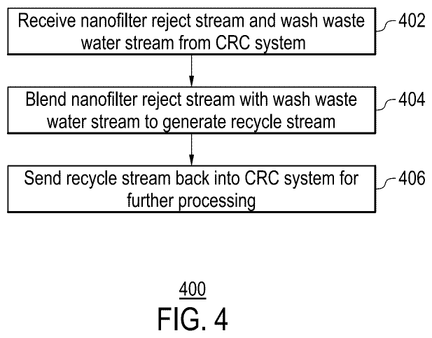

FIGS. 3A and 3B is an illustration of an apparatus 300 for the removal of ions from a brine stream using a recycle stream. The two parts of apparatus 300 depicted in two FIGS. 3A and 3B have been split into two parts for improved visibility and are rejoined together at circles 1, 2, and 3, to form one apparatus 300. In various embodiments, the apparatus 300 implements the method 400 of FIG. 4.

As shown in FIG. 3A, the apparatus 300 includes a pretreatment unit 302. The pretreatment unit 302 receives a brine feed 304 containing lithium and other metals. For example, the brine feed 304 may be received from a well, such as the well 102 of FIG. 1. In some embodiments, the brine feed 304 received from well may thus be a deep subsurface brine. The pretreatment unit 302 pretreats the brine feed 304 to remove vapor 306, solids 308, organics 310 from the output stream. For example, the vapor 306 can include water vapor as well as other gases, such as methane, ethane, propane, carbon dioxide, and nitrogen, among other gases. The solids 308 can include larger particles, such as solidified sulfates, phosphate, carbonates, silicas, sands, bits of rock, dirt, etc. The organics 310 can include methane, ethane, propane, butanes, pentanes, hextanes, heplanes-plus, carbon dioxide, hydrogen sulfide, pentanes-plus, etc. In some examples, the pretreatment unit 302 may include a sparging tank. For example, a sparging tank may be used by controlling the amount of air injected into the sparging tank to vary the composition of the brine feed 304. In particular, the air is used to knockout iron, silica, and entrained gas in the untreated brine feed 304 via chemical reactions. In some examples, the exact rate of air injection and vessel size of the of the sparging tank can be optimized based on the target composition of the brine feed 304. In some embodiments, the pretreatment unit 302 includes a three-phase separator. For example, the three-phase separator can remove gases and solids from the brine feed 304. In some embodiments, the pretreatment unit 302 includes a desander. For example, a desander uses a cyclone and centrifugal force to separate larger solids from brine droplets. Such larger solids may include various larger particles, such as sand or bits of rock on the scale of micrometers in size. In some embodiments, the pretreatment unit 302 includes a de-oiling cyclone. For example, the de-oiling cyclone can perform an additional cyclone removal for more trace oil from the brine feed 304. In various embodiments, such removed trace oils include acetate, propionate, glycolate, formate, among other potential trace oils.

The apparatus 300 is shown receiving freshwater make up 312 that is received at a direct lithium extraction (DLE) unit 314 that is fluidically coupled to the pretreatment unit 302. The DLE unit 314 swaps lithium out of the brine feed 304 into the freshwater make up 312. The DLE unit 314 can thus increase both the ratio of lithium to impurities and the lithium concentration in the pretreated brine stream. The outputs of the DLE unit 314 includes a spent brine stream 318. In various examples, the spent brine stream 318 includes byproducts of DLE processing and thus includes minimal lithium.

The apparatus 300 includes a mixer 320 that is fluidically coupled to the DLE unit 314. In various embodiments, the mixer 320 mixes the pretreated stream with one or more recycle streams to produce one blended stream, as discussed below. A first pump 322 then pumps the mixture into a first nanofiltration unit 324. The nanofiltration unit 324 is configured to remove solids from nanometer sized ions dissolved in solution. In various embodiments, the permeate of the filtration systems can be fed in parallel or series in a mainly liquid phase to various downstream filters, beginning with a divalent ion exchange (IX) 326. The nanofilter reject stream is recycled back into the pretreated brine to be mixed with other liquids at mixer 320.

The divalent ion exchange (IX) 326 interchanges one species of ion present in an insoluble solid with another of like charge in the pretreated brine stream. The divalent IX 326 specifically exchanges divalent ions for sodium ions or other monovalent ions. In one embodiment, the divalent IX 326 replaces Ca2+, Mg2+, Sr2+, Fe2+, Mn2+, Ba2+ ions for Na+ ions or other monovalent ions, depending on the specific resin used. In some embodiments, the divalent IX 326 is composed of a sodium loaded resin.

Still referring to FIG. 3A, the apparatus 300 further includes a boron ion exchange (IX) 328 fluidically coupled to the divalent IX 326. In various embodiments, the boron IX 328 further replaces boron ions with monovalent ions, such as sodium ions. For example, the boron IX 328 may be composed of sodium loaded resin.

The apparatus 300 includes another pump 330 to pump the output stream from the boron IX 328 into a first reverse osmosis unit 332, depicted in FIG. 3B. In some embodiments, the reverse osmosis unit 332 is a medium pressure reverse osmosis unit. In various embodiments, a medium pressure reverse osmosis unit may operate within the range of 600 to 1,800 pounds per square inch (psi), or 4,137 to 12,410 kilopascals (kPa). In some embodiments, the reverse osmosis unit 332 is a high pressure reverse osmosis unit. In various embodiments, a high pressure reverse osmosis unit operates at a pressure of greater than 1,800 psi or 12,410 kPa. In some embodiments, the reverse osmosis unit 332 includes a mix of medium pressure reverse osmosis and high pressure reverse osmosis filters. In various embodiments, the reverse osmosis unit 332 can filter out lithium and other elements from the stream and output reverse osmosis permeate 334 containing water and less than 1% of the feed lithium and sodium, as well as boron. In various embodiments, the amount of lithium in the reverse osmosis permeate 334 is less than 1000 ppm total, and likely lower than 100 ppm.

The apparatus 300 includes another pump 336 that pumps the output of the first reverse osmosis unit 332 into a second reverse osmosis unit 338. In some embodiments, the reverse osmosis unit 338 is a high pressure reverse osmosis unit. In various embodiments, a high pressure reverse osmosis unit operates at a pressure of greater than 1,800 psi or 12,410 kPa. For example, the reverse osmosis unit 338 filters out additional lithium and other elements from the stream and outputs reverse osmosis permeate 334 containing water and less than 1% of the feed lithium and sodium, as well as boron, from the stream and outputs additional reverse osmosis permeate 334 containing pure water.

Still referring to FIG. 3B, the apparatus 300 includes a polishing ion exchange unit 340 fluidically coupled to the reverse osmosis unit 338. In various embodiments, the polishing ion exchange unit 340 further replaces additional undesired ions with sodium ions.

The apparatus 300 also further includes an evaporator 342 fluidically coupled to the polishing ion exchange unit 340. In various embodiments, the evaporator 342 generates evaporation condensate 346. For example, the evaporation condensate 346 includes water and other evaporated solvents.

The apparatus 300 includes a lithium carbonation unit 348 fluidically coupled to the evaporator 342. In various embodiments, the lithium carbonation unit 348 converts lithium salts, such as lithium chloride, into lithium carbonate crystals. The lithium carbonation unit 348 also outputs lithium carbonate waste 354. For example, the lithium carbonate waste 354 includes some amounts of lithium, as well as potassium, and large amounts of sodium, and trace amounts of calcium, magnesium, boron, and other divalents.

The apparatus 300 includes a washing unit 356 coupled to the lithium carbonation unit 348. In various embodiments, the washing unit 356 washes lithium carbonate crystals from the lithium carbonation unit 348 using pure water make up 358. In various embodiments, the pure water make up 358 is pure deionized (DI) water. The washing unit 356 outputs solids 362 to be sent to a dryer and wash waste water 364. In various embodiments, the solids 362 are composed of mostly lithium carbonate.

As shown in FIGS. 3A and 3B, the reject stream from the nanofiltration unit 324, the lithium carbonate waste 354, and the wash waste water 364, are recycled back into the apparatus 300 at just before the mixer 320. In various embodiments, the reject stream from the nanofiltration unit 324 and the lithium carbonate waste 354 can further be mixed at a target ratio. For example, the target ratio may depend on the specific compositions of the reject stream from the nanofiltration unit 324, the lithium carbonate waste 354, and the wash waste water 364. In various embodiments, the ratio of the reject stream from the nanofiltration unit 324, the lithium carbonate waste 354, and the wash waste water 364 may be adjusted such that the ratio of lithium to monovalents and the ratio of lithium to divalents in the resulting blended mix produced by mixer 320 is similar to the output feed from the DLE 314.

FIG. 4 is a process flow diagram of a method 400 for recycling reject and waste water streams. In various examples, the method 400 may be implemented using the apparatus 200A or 200B of FIGS. 2A and 2B, or the apparatus 300 of FIGS. 3A and 3B, or the apparatus 100 of FIG. 1.

At block 402, a nanofilter reject stream and a wash waste water stream is received from a concentration, refinement, and conversion (CRC) system. For example, the nanofilter reject stream and a wash waste water stream may both be byproducts of the processing of an input stream from a DLE. In various embodiments, the nanofilter reject stream is a stream output from a nanofilter that is relatively higher than the input stream in a ratio of divalents, such as calcium, to lithium. As used herein, relatively higher refers to one stream having a higher ratio relative to the ratio in another stream. In various examples, the nanofilter reject stream may include a percentage of lithium from the original feed in the range of one to ten percent. The nanofilter reject stream may also be relatively lower than the wash waste water stream in a ratio of monovalents to lithium. By contrast, the wash waste water stream is a stream that is relatively higher than both the input stream and the nanofilter reject stream in a ratio of monovalents, such as sodium, to lithium. The wash waste water stream is also further relatively lower than the input stream or nanofilter reject stream in divalents. In some embodiments, the received wash water stream may be a mix of a selected number of wash waste streams. For example, a number of wash waste streams may be generated by successively washing lithium carbonate crystals with fresh water. In some embodiments, the first wash may be discarded, with subsequent waste washes selected to be mixed to generate a selected wash waste stream.

At block 404, the nanofilter reject stream is blended with the wash waste water stream to generate a recycle stream. For example, the nanofilter reject stream is blended with the wash waste water stream at a predetermined ratio. In one embodiment, the ratio is a 1:2 ratio of nanofilter reject stream to wash water stream. In various embodiments, any suitable ratio may be used based on the amount of monovalents in the wash waste water stream and the amount of divalents in the nanofilter reject stream. In some embodiments, the ratio of the nanofilter reject stream to the wash water stream is adjusted such that the ratio of lithium to monovalents in the blended stream is roughly the same as the ratio of lithium to monovalents in the input stream. Similarly, the ratio of the nanofilter reject stream to the wash water stream is adjusted such that the ratio of lithium to divalents in the blended stream is roughly the same as the ratio of lithium to divalents in the input stream. In some embodiments, a lithium carbonate waste stream is also mixed into the recycle stream. In various embodiments, any combination of a nanofilter reject stream, a wash waste water stream, and a lithium carbonate waste stream is blended to generate the recycle stream. For example, the lithium carbonate waste stream may have a higher lithium to divalent ratio and a lower lithium to monovalent ratio than the nanofilter reject stream and the wash waste stream. In various embodiments, the generated recycle stream may have higher concentrations of impurities such as sodium, calcium, and magnesium than the original received DLE feed, but the ratio of lithium to impurities in the generated recycle stream may be far lower than the ratio in the reject stream or the wash waste water stream.

At block 406, a recycle stream is sent back into the CRC system for further processing. For example, the recycle stream may be input into any suitable stage of a nanofiltration unit from which the nanofilter reject stream was received. In some embodiments, the recycle stream is input into an ion exchange mechanism of the CRC system. In these embodiments, the recycle stream may first be filtered via a separate nanofiltration unit prior to being sent to the ion exchange mechanism. In some embodiments, if the recycle stream is filtered using a dedicated nanofiltration train, then the train may be specially operated with anti-scalants and other measures. For example, in some embodiments, anti-scalants or a dedicated membrane train is added to the recycled feed and more preventative measures are taken. Example preventative measures includes more acidic pH, more clean in place, etc.

The process flow diagram of FIG. 4 is not intended to indicate that the processes of the method 400 are to be executed in any particular order, or that all of the processes of the method 400 are to be included in every case. Additionally, the method 400 can include any suitable additional processing of the brine. For example, in some embodiments, the method 400 may include the use of a separate nanofiltration train that is dedicated to the recycle stream. For example, the recycle stream may be filtered via the dedicated nanofiltration train before being returned to the CRC system and input at an ion exchange stage of the CRC system.

### Embodiments of Present Techniques

In one or more embodiments, the present techniques may be susceptible to various modifications and alternative forms, such as the following embodiments as noted in paragraphs 1 to 36:
1. An apparatus for brine filtration includes a recycling unit to receive a nanofilter reject stream and a wash waste water stream from a concentration, refinement, and conversion (CRC) system. The recycling unit is to blend the nanofilter reject stream and the wash waste water stream to generate a recycle stream. The recycling unit is to send the recycle stream back into the CRC system to extract lithium from the recycle stream.
2. The apparatus of paragraph 1, where the nanofilter reject stream includes a relatively higher ratio of divalents to lithium and the wash waste water stream includes a relatively higher ratio of monovalents to lithium.
3. The apparatus of paragraph 2, where the divalents include calcium and the monovalents include sodium.
4. The apparatus of any of paragraphs 1-3, where the recycling unit includes a nanofiltration train that filters the recycle stream prior to sending the filtered recycle stream back into the CRC system.
5. The apparatus of paragraph 4, where the filtered recycle stream is input into an ion exchange mechanism of the CRC system.
6. The apparatus of any of paragraphs 1-5, where the recycle stream is input into a nanofiltration unit of the CRC system.
7. The apparatus of any of paragraphs 1-6, where the wash waste water stream includes a number of selected wash water streams generated by a washing unit of the CRC system.
8. The apparatus of paragraph 7, where the number of selected wash water streams are selected based on a threshold concentration of a monovalent.
9. The apparatus of paragraph 8, where the monovalent includes sodium.
10. The apparatus of any of paragraphs 1-9, where a ratio of lithium to impurities in the generated recycle stream is lower than a ratio of lithium to impurities in the nanofilter reject stream and the ratio of lithium to impurities in the wash waste water stream.
11. The apparatus of any of paragraphs 1-10, including a nanofiltration system to generate the nanofilter reject stream, where the nanofiltration system is individually sub-optimally configured with respect to lithium extraction.
12. The apparatus of any of paragraphs 1-11, including a washing unit to generate the wash waste water stream, where the washing unit is individually sub-optimally configured with respect to lithium extraction.
13. The apparatus of any of paragraphs 1-12, where the recycling unit is to process the recycle stream with an anti-scalant before sending the recycle stream back into the CRC system.
14. A method of producing a recycle stream includes receiving a nanofilter reject stream and a wash waste water stream from a concentration, refinement, and conversion (CRC) system. The method includes blending the nanofilter reject stream and the wash waste water stream to generate the recycle stream. The recycle stream is to be sent back into the CRC system.
15. The method of paragraph 14, further including sending the recycle stream back into the CRC system for further processing.
16. The method of paragraph 15, further including processing the recycle stream with an anti-scalant before sending the recycle stream back into the CRC system.
17. The method of paragraph 15, where the recycle stream is sent back into a nanofiltration system of the CRC system.
18. The method of paragraph 17, where the recycle stream is sent back into an advanced stage of the nanofiltration system.
19. The method of paragraph 15, where the recycle stream is sent back into an ion exchange system of the CRC system.
20. The method of any of paragraphs 14-19, where the nanofilter reject stream and the wash waste water stream are blended at a predetermined volumetric ratio.
21. The method of paragraph 20, where the predetermined volumetric ratio is based on the composition of monovalents and divalents in the nanofilter reject stream and the wash waste water stream.
22. The method of any of paragraphs 14-20, where generating the recycle stream further includes blending the nanofilter reject stream and the wash waste water stream with a lithium carbonate waste stream.
23. A recycled brine composition includes a blend of output streams from a concentration, refinement, and conversion (CRC) system. The output streams include a nanofilter reject stream and a wash waste water stream. The nanofilter reject stream includes a relatively higher ratio of divalents to lithium than the wash waste water stream. The wash waste water stream includes a relatively higher monovalent to lithium ratio than the nanofilter reject stream. Each of the output streams include lithium.
24. The recycled brine composition of paragraph 23, where the blend further includes an anti-scalant.
25. The recycled brine composition of any of paragraphs 23 and 24, where the blend of output streams further includes a lithium carbonate waste stream.
26. The recycled brine composition of paragraph 25, where the lithium carbonate waste stream includes a relatively higher ratio of lithium to divalents than the wash waste water stream.
27. The recycled brine composition of any of paragraphs 25 and 26, where the lithium carbonate waste stream includes a relatively lower ratio of lithium to monovalents than the wash waste water stream.
28. The recycled brine composition of any of paragraphs 25-27, where the lithium carbonate waste stream includes a relatively higher ratio of lithium to divalents than the nanofilter reject stream.
29. The recycled brine composition of any of paragraphs 25-28, where the lithium carbonate waste stream includes a relatively lower ratio of lithium to monovalents than the nanofilter reject stream.
30. The recycled brine composition of any of paragraphs 25-29, where the lithium carbonate waste stream includes a relatively higher ratio of lithium to divalents than an input stream of the CRC system.
31. The recycled brine composition of any of paragraphs 25-30, where the lithium carbonate waste stream includes a relatively lower ratio of lithium to monovalents than an input stream of the CRC system.
32. The recycled brine composition of any of paragraphs 23-31, where the nanofilter reject stream includes a relatively lower ratio of lithium to divalents than an input feed stream of the CRC system.
33. The recycled brine composition of any of paragraphs 23-32, where the nanofilter reject stream includes a relatively lower ratio of lithium to monovalents than an input feed stream of the CRC system.
34. The recycled brine composition of any of paragraphs 23-33, where the wash waste water stream includes a relatively higher ratio of lithium to divalents than an input feed stream of the CRC system.
35. The recycled brine composition of any of paragraphs 23-34, where the wash waste water stream includes a relatively lower ratio of lithium to monovalents than an input feed stream of the CRC system.
36. The recycled brine composition of any of paragraphs 23-35, where the monovalents include sodium.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. An apparatus for brine filtration, comprising:
a recycling unit to:
receive a nanofilter reject stream and a wash waste water stream from a concentration, refinement, and conversion (CRC) system;
blend the nanofilter reject stream and the wash waste water stream to generate a recycle stream; and
send the recycle stream back into the CRC system to extract lithium from the recycle stream.

2. The apparatus of claim 1, wherein the nanofilter reject stream comprises a relatively higher ratio divalents to lithium than the wash waste water stream and the wash waste water stream comprises a relatively higher ratio of monovalents to lithium than the nanofilter reject stream.

3. The apparatus of claim 2, wherein the divalents comprise calcium and the monovalents comprise sodium.

4. The apparatus of claim 1, wherein the recycling unit comprises a nanofiltration train that filters the recycle stream prior to sending the filtered recycle stream back into the CRC system.

5. The apparatus of claim 4, wherein the filtered recycle stream is input into an ion exchange mechanism of the CRC system.

6. The apparatus of claim 1, wherein the recycle stream is input into a nanofiltration unit of the CRC system.

7. The apparatus of claim 1, wherein the wash waste water stream comprises a plurality of selected wash water streams generated by a washing unit of the CRC system.

8. The apparatus of claim 7, wherein the plurality of selected wash water streams are selected based on a threshold concentration of a monovalent.

9. The apparatus of claim 1, wherein a ratio of lithium to impurities in the generated recycle stream is lower than a ratio of lithium to impurities in the nanofilter reject stream and the ratio of lithium to impurities in the wash waste water stream.

10. The apparatus of claim 1, comprising a nanofiltration system to generate the nanofilter reject stream, wherein the nanofiltration system is individually sub-optimally configured with respect to lithium extraction.

11. A method of producing a recycle stream, comprising:
receiving a nanofilter reject stream and a wash waste water stream from a concentration, refinement, and conversion (CRC) system; and
blending the nanofilter reject stream and the wash waste water stream to generate the recycle stream, wherein the recycle stream is to be sent back into the CRC system.

12. The method of claim 11, further comprising sending the recycle stream back into the CRC system for further processing.

13. The method of claim 12, further comprising processing the recycle stream with an anti-scalant before sending the recycle stream back into the CRC system.

14. The method of claim 12, wherein the recycle stream is sent back into a nanofiltration system of the CRC system.

15. The method of claim 14, wherein the recycle stream is sent back into an advanced stage of the nanofiltration system.

16. The method of claim 12, wherein the recycle stream is sent back into an ion exchange system of the CRC system.

17. The method of claim 11, wherein the nanofilter reject stream and the wash waste water stream are blended at a predetermined volumetric ratio.

18. A recycled brine composition, comprising:
a blend of output streams from a concentration, refinement, and conversion (CRC) system, wherein the output streams comprise a nanofilter reject stream and a wash waste water stream, wherein the nanofilter reject stream comprises a relatively higher ratio of divalents to lithium than the wash waste water stream, and wherein the wash waste water stream comprises a relatively higher monovalent to lithium ratio than the nanofilter reject stream, wherein each of the output streams comprise lithium.

19. The recycled brine composition of claim 18, wherein the blend further comprises an anti-scalant.

20. The recycled brine composition of claim 18, wherein the blend of output streams further comprises a lithium carbonate waste stream.

21. The recycled brine composition of claim 20, wherein the lithium carbonate waste stream comprises a relatively higher ratio of lithium to divalents than the wash waste water stream.

22. The recycled brine composition of claim 20, wherein the lithium carbonate waste stream comprises a relatively lower ratio of lithium to monovalents than the wash waste water stream.

23. The recycled brine composition of claim 20, wherein the lithium carbonate waste stream comprises a relatively higher ratio of lithium to divalents than the nanofilter reject stream.

24. The recycled brine composition of claim 20, wherein the lithium carbonate waste stream comprises a relatively lower ratio of lithium to monovalents than the nanofilter reject stream.

25. The recycled brine composition of claim 20, wherein the lithium carbonate waste stream comprises a relatively higher ratio of lithium to divalents than an input stream of the CRC system.
